(19) United States
(12) Patent Application Publication
(10) Pub. No.: US 2025/0033303 A1
(43) Pub. Date: Jan. 30, 2025

(54) RESIN-FREE SEALING AGENT FOR PROVISIONALLY SEALING PNEUMATIC VEHICLE TYRES, SEALING AGENT CONTAINER COMPRISING SAME, METHOD FOR PROVISIONALLY SEALING A PNEUMATIC VEHICLE TYRE, AND USE

(71) Applicant: Continental Reifen Deutschland GmbH, Hannover (DE)

(72) Inventor: Markus Dahlke, Wunstorf (DE)

(73) Assignee: Continental Reifen Deutschland GmbH, Hannover (DE)

(21) Appl. No.: 18/707,397

(22) PCT Filed: Oct. 20, 2022
(86) PCT No.: PCT/DE2022/200240

§ 371 Date: May 3, 2024

(30) Foreign Application Priority Data
Nov. 4, 2021 (DE) 10 2021 212 408.9

(51) Int. Cl. B29C 73/16; B29K 7/00; B29K 105/00; B29L 30/00

(52) U.S. Cl. CPC B29C 73/163; B29C 73/166; B29K 2007/00; B29K 2105/0047; B29K 2105/0058; B29L 2030/00

(57) ABSTRACT

The invention relates to a resin-free sealant for temporary sealing of pneumatic vehicle tires, wherein the sealant comprises at least one rubber latex, at least one stabilizer and water. The invention further relates to a sealant vessel comprising a resin-free sealant and to a method of temporary sealing of a pneumatic vehicle tire.

### CROSS-REFERENCE TO RELATED APPLICATIONS

The present application is a National Stage Application under 35 U.S.C. § 371 of International Patent Application No. PCT/DE2022/200240 filed on Oct. 20, 2022, the disclosures of which are herein incorporated by reference in their entireties

### BRIEF SUMMARY

The invention relates to a resin-free sealant for temporary sealing of pneumatic vehicle tires according to the preamble of claim 1, and to a sealant vessel comprising such a resin-free sealant according to the preamble of claim 8. The invention also relates to a method of temporary sealing of pneumatic vehicle tires according to the preamble of claim 9, and to the use of such a sealant according to the preamble of claim 10.

When pneumatic vehicle tires run over sharp articles, they can suffer damage in the form of tears that lead to a loss of air pressure in the tire. In order to seal such damage at least temporarily, i.e. for a certain period of time before the vehicle tire is changed, with maximum reliability, there are known prior art sealants that are introduced into the tire, for example with the aid of a tire repair kit, after the valve insert has been screwed out or directly via the valve. Such a tire repair kit typically includes a pressure source and a sealant vessel or at least one connector for a sealant vessel. Alternatively, the sealant is expressed directly from the vessel into the tire by the user.

EP 3 227 097 B1 discloses, for example, a sealing means comprising a rubber latex, tackifying resin and antifreeze. A disadvantage of the sealants described in the prior art is that the compositions do not have the desired properties in relation to sealing performance for a tire.

This is the starting point of the present invention. It is an object of the present invention to provide an improved sealant having improved performance, especially in relation to pumpability and sealing performance. It is a further object of the present invention to provide an improved sealant vessel comprising a sealant, by means of which a pneumatic vehicle tire is better sealed.

The object of the invention is achieved by a resin-free sealant for temporary sealing of pneumatic vehicle tires, having the features of claim 1. The object is further achieved by a sealant vessel having the features of claim 8 and by a method of temporary sealing of pneumatic vehicle tires having the features of claim 9.

The object is achieved by a resin-free sealant for temporary sealing of pneumatic vehicle tires, comprising at least one rubber latex, at least one stabilizer and water.

The resin-free sealant of the invention surprisingly has distinctly improved sealing performance. This ultimately leads to improved functionality possessed by the sealant of the invention by comparison with current sealants. Further advantageous performance features are exhibited by the resin-free sealant of the invention with regard to pumpability and aerosol efficiency. The resin-free sealant can also be produced inexpensively.

Unless stated otherwise, all weight data are based on the total amount of sealants or on the total amount of compositions for temporary sealing of pneumatic vehicle tires.

### DETAILED DESCRIPTION

In one embodiment of the invention, the rubber latex comprises NR latex or consists of NR latex. The rubber latex may be a natural rubber latex (NR) from Hevea brasiliensis or else latex from the guayule shrub (Parthenium argentatum), where the natural rubber latex may be used in deprotonated form. A conceivable alternative is that the latex is synthetically produced and used. For this purpose, the use of various blended latices and of a mixture of NR and synthetic latex is likewise conceivable.

In a preferred embodiment of the invention, sealant has a latex content in the range from 27% to 46% by weight, preferably in the range from 36% to 45% by weight. A significant advantage of such a sealant having this latex content is that pumpability and aerosol efficiency are distinctly improved, and so the sealant has higher performance.

In one embodiment of the invention, the sealant comprises at least one antifreeze, preferably at least two antifreezes, in particular where at least one antifreeze includes at least one glycol selected from the group consisting of ethanediol and propanediol. The antifreeze in the present context has a low freezing point, typically below −10° C. In conjunction with water, the freezing point is even lower and can reach −55° C. in the correct mixture. Advantageously, the sealant having a low freezing point can be used in colder regions without significant impairment of pumpability and flowability. More preferably, the first antifreeze comprises 1,2-ethanediol, and the second antifreeze 1,2-propanediol. Both antifreezes are water-miscible and lower the freezing point. It is also advantageous that the sealant comprising such an antifreeze is more environmentally friendly.

In a further embodiment of the invention, the total proportion of antifreeze is preferably in the range from 27% to 40% by weight, in particular where the proportion of the first antifreeze is in the range from 20% to 25% by weight and the proportion of the second antifreeze is in the range from 7% to 15% by weight. Advantageously, this total proportion of antifreeze is optimal for freezing point depression of the overall sealant, such that it can be used with optimal pumpability and flowability and improved sealing properties even at relatively low temperatures.

In a further embodiment of the invention, the at least one stabilizer is a surfactant, preferably where the total proportion of the surfactant is in the range from 0.25% to 5% by weight. Advantageously, the at least one surfactant stabilizes at least the latex and in particular an antifreeze, as a result of which the resin-free sealant is stabilized overall.

More preferably, the sealant comprises two surfactants, where the total proportion of the first and second surfactants is in the range from 0.5% to 2% by weight. Advantageously, the two surfactants can interact with one another and with other constituents, such that conveying properties and sealing properties are improved.

Further preferably, the at least one surfactant includes one or more sulfonates, especially anionic mono- or disulfonates and/or at least one alkyl ether sulfate, for example sodium alkylphenol polyethylene glycol ether sulfate, and at least one steric surfactant. These are advantageously good foam formers, which distinctly improves sealing in the pneumatic vehicle tire. Steric surfactants show good viscosity—and foam-regulating action in relation to the sealant.

In a further embodiment of the invention, the resin-free sealant comprises further additions. For instance, it is possible to add aging stabilizers or preservatives to the resin-free sealant to make sure that the sealant will be ready for use in the case of storage. It may also additionally be the case that the sealant comprises dispersants and/or emulsifiers and/or pH regulators. A significant benefit is that the resin-free sealant shows much better sealing performance.

In a preferred embodiment, the sealant contains 1% to 2% by weight of at least one aging stabilizer, in particular dispersions of sterically and alkylated (poly)phenols and/or alkylated diphenylamines. Advantageously, the shelf life of the sealant can thus be extended.

In a further embodiment, the resin-free sealant comprises fillers that contribute to sealing, especially of large holes. Examples include fibrous materials, especially natural and synthetic fibers, sheet silicates, silica, talc, chalk, carbon black, ground rubber and the like.

The resin-free sealant, in a further embodiment of the invention, has a viscosity at 25° C. of 3 to 23 mPa*s, especially 6 to 16 mPa*s (dynamic viscosity on a rheometer, 0.5° cone, 16 000 rpm). This distinctly improves the flow properties of the sealant.

In a further embodiment of the invention, the water content of the resin-free sealant is in the range from 15% to 30% by weight, especially in the range from 20% to 25% by weight. This is done using a latex, which is an up to 85% by weight, preferably up to 70% by weight, aqueous dispersion (emulsion). This means that the proportion of solids in the dispersion based on the total weight is up to 85% by weight, preferably up to 70% by weight. Alternatively, the proportion of solids in the dispersion based on the total weight may be in the range from 85% to 70% by weight, especially in the range from 80% to 75% by weight. Advantageously, the resin-free sealant having such a water content and/or solids content has much higher performance in relation to sealing properties without the use of a resin.

Moreover, the object of the present invention is achieved by a sealant vessel comprising a resin-free sealant as described, wherein the sealant vessel has an opening through which the resin-free sealant can be conveyed into a vehicle tire.

Advantageously, the sealant vessel of the invention is easy to use since the resin-free sealant can flow easily out of the sealant vessel. It is conceivable that the user will be able to manually press or squeeze the vessel in order to convey the sealant into the vehicle tire. For this purpose, the vessel may be connected to the vehicle tire valve, for example via a hose. Alternatively, such a vessel may be connected to a tire repair kit via a hose. It is likewise conceivable to squeeze out the resin-free sealant into a tire repair kit, in which case the tire repair kit is designed to generate compressed air with the aid of a compressor, which conveys the resin-free sealant into the vehicle tire.

The details and benefits in relation to the resin-free sealant are likewise applicable, vice versa, to the resin-free sealant comprised by the sealant vessel.

In one embodiment of the invention, the sealant vessel can be connected to a tire repair kit. For this purpose, the sealant vessel has a connector that can be connected to a tire repair kit, for example via a plug-in or rotation mechanism. Advantageously, such a sealant vessel may be connected to a tire repair kit, which considerably simplifies user operation. It has also been found that the sealant vessel comprising a resin-free sealant leads to a distinct improvement in sealing performance.

The object of the present invention is also achieved by a method of temporary sealing of a pneumatic vehicle tire using at least one resin-free sealant. Such a method makes it easier for the user to seal a pneumatic vehicle tire since the sealing performance of the resin-free sealant has been significantly improved.

The details and benefits in relation to the resin-free sealant and the sealant vessel are likewise applicable, vice versa, to the method of the invention.

In one embodiment of the method of the invention, the sealant is sprayed in through a valve of the pneumatic vehicle tire. This can especially be effected by means of a tire repair kit, where the tire repair kit comprises a compressor that generates compressed air. The compressed air generated conveys the sealant through a hose into the vehicle tire.

The invention further relates to the use of a resin-free sealant as described in a tire repair kit for a pneumatic vehicle tire.

Further benefits and features of the resin-free sealant of the invention and of the sealant vessel and of the method will be apparent not only from the description but additionally also from the dependent claims, which relate to advantageous configurations of the present invention and as such should not be considered to be restrictive. The invention also encompasses combinations of the features of different dependent claims, even if the dependent claims do not relate to one another or if they belong to different claim categories. Furthermore, combinations of preferred and particularly preferred embodiments can also be combined with one another. This is also true of the individual features of the subsequently discussed working examples where the person skilled in the art is unable to discern that they necessarily belong together.

The invention is to be elucidated in detail by the working examples that follow. The example identified by “C” is a comparative example. Inventive compositions are identified by “I”.

It can be inferred from table 1 that the inventive example shows much better sealing performance. For the user, this leads to improved functionality of the sealant compared to sealants comprising a resin.

### Substances Used

a) solids content 60% by weight, LATZ natural latex, e.g. Weber & Schaer
b) rosin ester, solids content 50% by weight, Tacolyn, Eastman Chemical Company
c) aromatically modified terpene resin, Nanolet TO, Yasuhara chemical Co. Ltd
d) anionic disulfonate, active solids content 51% by weight
e) sodium trialkylphenol polyethylene glycol ether sulfate, active solids content 25% by weight
f) resin/latex ratio in relation to the solids content of latex and resin

TABLE 1

| | Unit | I1 | C1 | C2 | C3 |
|---|---|---|---|---|---|
| Constituents | | | | | |
| Natural rubber latex (a) | % by | 42 | 42 | 42 | 28 |
| | wt. | | | | |
| Tackifying resin (b) or (c) | % by | — | 22 | 6 | 6 |
| | wt. | | | | |
| Surfactant (d), (e) | % by | 2.5 | 2.5 | 2.5 | 2.5 |
| | wt. | | | | |
| 1,2-ethanediol | % by | 24 | 24 | 24 | 24 |
| | wt. | | | | |
| 1,2-propanediol | % by | 9.2 | 4.2 | 7.8 | 11.8 |
| | wt. | | | | |
| Water | % by | 22.3 | 5.3 | 17.7 | 27.7 |
| | wt. | | | | |
| Properties | | | | | |
| Sealing performance after | | 8/10 | 3/10 | 5/10 | 5/10 |
| two cycles | | | | | |
| Pumpability | s | 397 | 436 | 403 | 413 |
| Aerosol efficiency | kPa | 62 | 40 | 54 | 55 |

### Definitions

In the context of the invention, sealing performance is ascertained by introducing the sealant into a defective pneumatic vehicle tire and simulating a first driving cycle for 10 minutes. Then the integrity of the vehicle tire is tested with a leak-finding spray, with classification into the airtight state and the leaky state. In the case of an illustrative number of 4/10, 10 pneumatic vehicle tires were tested, of which 4 were airtight and 6 were leaky after the 10 minutes. After the first driving cycle, a second driving cycle is conducted for 10 minutes, and then integrity is tested again.

In the context of the invention, pumpability is ascertained by testing system performance in a test setup consisting of wheel, tire valve and compressor sealant system as follows:

The wheel is filled with sealant and compressed air with the aid of the compressor until a target filling pressure of 220 kPa has been attained. During this operation, the prevailing pressure in the compressor and in the wheel is measured simultaneously. When the target filling pressure of 220 kPa has been attained, the filling operation is stopped and the time taken to reach this 220 kPa is noted. The shorter the period of time required, the more stable the sealant mixture with regard to drying-out and shear-induced coagulation. A short system run time is the most advantageous for the end user.

In addition, aerosol efficiency is ascertained in the context of the invention by using the following test setup:

A wheel consisting of tire and wheel rim is penetrated at a defined point by a nail having a diameter of 6 mm in the tread of a tire. This creates a hole which, if the tire is filled with air, can be characterized by the pressure drop per unit time. What is specifically measured is the pressure drop from 250 kPa that occurs after one minute. The greater the pressure drop, the larger the hole in the tire.

In order to determine aerosol sealing efficiency, the pressure drop from 250 kPa within one minute is determined accurately twice: once before the sealant has been transferred into the wheel with the aid of the compressor and for a second time after the sealant has been transferred into the wheel with the aid of the compressor. During the sealant transfer, a sealant-air mixture (aerosol) is formed in the wheel, which is transported through the hole in the tread of the tire by virtue of the positive pressure in the tire. This mixture has the ability to coagulate under shear. For those reasons (positive pressure, coagulation capacity), the hole is significantly reduced in size by the sealant, which correlates with a smaller pressure drop from 250 kPa over a period of one minute. In order then to determine the aerosol sealing efficiency, the difference in pressure drops “wheel without sealant” and “wheel with sealant” is formed. The greater the difference, the more efficient the sealant, in terms of its aerosol efficiency. This is also the most advantageous for the user, since the total pumping time of the system is also shortened.

### EMBODIMENTS

1. A resin-free sealant for temporary sealing of pneumatic vehicle tires, characterized in that the sealant comprises at least one rubber latex, at least one stabilizer and water.
2. The resin-free sealant as claimed in claim 1, characterized in that the rubber latex comprises NR latex or consists of NR latex.
3. The resin-free sealant as claimed in claim 1 or 2, characterized in that the sealant has a latex content in the range from 27% to 46% by weight, preferably in the range from 36% to 45% by weight.
4. The resin-free sealant as claimed in any of the preceding claims, characterized in that the sealant comprises at least one antifreeze, preferably at least two antifreezes, in particular where at least one antifreeze includes at least one glycol selected from the group consisting of ethanediol and propanediol.
5. The resin-free sealant as claimed in claim 4, characterized in that the total proportion of antifreeze is in the range from 27% to 40% by weight, in particular where the proportion of the first antifreeze is in the range from 20% to 25% by weight and the proportion of the second antifreeze is in the range from 7% to 15% by weight.
6. The resin-free sealant as claimed in any of the preceding claims, characterized in that the at least one stabilizer is a surfactant, preferably where the total proportion of the surfactant is in the range from 0.25% to 5% by weight.
7. The resin-free sealant as claimed in any of the preceding claims, characterized in that the water content is in the range from 15% to 30% by weight, especially in the range from 20% to 25% by weight.
8. A sealant vessel comprising a resin-free sealant as claimed in any of the preceding claims, characterized in that the sealant vessel has an opening through which the resin-free sealant can be conveyed into a vehicle tire.
9. The sealant vessel as claimed in claim 8, characterized in that the sealant vessel is connectable to a tire repair kit.
10. A method of temporary sealing of a pneumatic vehicle tire using at least one resin-free sealant as claimed in any of claims 1 to 7.
11. The method as claimed in claim 10, characterized in that the sealant is sprayed in through a valve of the pneumatic vehicle tire.
12. The use of a resin-free sealant as claimed in any of claims 1 to 7 in a tire repair kit for a pneumatic vehicle tire.

1. A resin-free sealant for temporary sealing of pneumatic vehicle tires, the sealant comprises at least one rubber latex, at least one stabilizer and water.

2. The resin-free sealant as claimed in claim 1, wherein the rubber latex comprises NR latex or consists of NR latex.

3. The resin-free sealant as claimed in claim 1 wherein the sealant has a latex content in the range from 27% to 46% by weight, preferably in the range from 36% to 45% by weight.

4. The resin-free sealant of claim 1, wherein the sealant comprises at least one antifreeze, preferably at least two antifreezes, in particular where at least one antifreeze includes at least one glycol selected from the group consisting of ethanediol and propanediol.

5. The resin-free sealant as claimed in claim 4, wherein the total proportion of antifreeze is in the range from 27% to 40% by weight, in particular where the proportion of the first antifreeze is in the range from 20% to 25% by weight and the proportion of the second antifreeze is in the range from 7% to 15% by weight.

6. The resin-free sealant of claim 1, wherein the at least one stabilizer is a surfactant, preferably where the total proportion of the surfactant is in the range from 0.25% to 5% by weight.

7. The resin-free sealant of claim 1, wherein the water content is in the range from 15% to 30% by weight, especially in the range from 20% to 25% by weight.

8. A sealant vessel comprising:
the sealant vessel has an opening through which a resin-free sealant can be conveyed into a vehicle tire; and
the resin free sealant comprising:
at least one rubber latex comprising a natural rubber (NR) latex, in a range from 36% to 45% by weight, and a plurality of antifreezes;
at least one stabilizer;
water in the range from 20% to 25% by weight;
wherein the plurality of antifreezes comprises at least one glycol selected from the group consisting of ethanediol and propanediol; and
wherein the at least one stabilizer is a surfactant in a range from 0.25% to 5% by weight.

9. (canceled)

10. (canceled)

11. A resin-free sealant for temporary sealing of pneumatic vehicle tires, the sealant comprising:
at least one rubber latex comprising a natural rubber (NR) latex, in a range from 36% to 45% by weight, and a plurality of antifreezes;
at least one stabilizer; and
water in the range from 20% to 25% by weight;
wherein the plurality of antifreezes comprises at least one glycol selected from the group consisting of ethanediol and propanediol
wherein the at least one stabilizer is a surfactant in a range from 0.25% to 5% by weight.

12. A method of sealing a pneumatic vehicle tire comprising:
simulating a driving cycle;
testing an integrity of a vehicle tire with a leak-finding spray;
simulating a second driving cycle;
testing a second integrity of the vehicle tire after the second driving cycle;
filling the vehicle tire with a resin-free sealant and compressed air until a target pressure has been attained;
measuring a compressor prevailing pressure and a tire pressure while filling the vehicle tire;
determining a time taken to reach the target pressure;
determining stability of the resin-free sealant based on the determined time; and
wherein the resin free sealant comprises:
at least one rubber latex comprising a natural rubber (NR) latex, in a range from 36% to 45% by weight, and a plurality of antifreezes;
at least one stabilizer;
water in the range from 20% to 25% by weight;
wherein the plurality of antifreezes comprises at least one glycol selected from the group consisting of ethanediol and propanediol; and
wherein the at least one stabilizer is a surfactant in a range from 0.25% to 5% by weight.

13. The method of claim 12, further comprising determining aerosol efficiency comprising:
creating a hole in a vehicle tire having a pressure drop per unit time;
measuring a pressure drop after a period of time and before the resin-free sealant is added;
measuring a second pressure drop after the period of time after the resin-free sealant is added; and
determining a difference between the second pressure drop and the pressure drop as an aerosol efficiency.
